(19) United States
(12) Patent Application Publication
(10) Pub. No.: US 2023/0022500 A1
(43) Pub. Date: Jan. 26, 2023

(54) CONTENT DETERMINATION DEVICE, CONTENT DETERMINATION METHOD, AND STORAGE MEDIUM

(71) Applicant: Sharp NEC Display Solutions, Ltd., Tokyo (JP)

(72) Inventor: Akira UCHIYAMA, Tokyo (JP)

(21) Appl. No.: 17/960,418

(22) Filed: Oct. 5, 2022

Related U.S. Application Data
(63) Continuation of application No. PCT/JP2020/017233, filed on Apr. 21, 2020.

(51) Int. Cl. G06Q 30/02

(52) U.S. Cl. CPC G06Q 30/0244

(57) ABSTRACT

A content attribute acquisition unit acquires a plurality of pieces of content attribute information respectively indicating attributes of a plurality of contents to be displayed before a main part of a movie. An order determination unit determines, using the plurality of pieces of content attribute information, a display order of the plurality of contents and outputs order information indicating the display order to a screening content generation device. A content storage unit stores the plurality of contents as well as the plurality of pieces of content attribute information. The content attribute acquisition unit acquires the plurality of pieces of content attribute information from the content storage unit, and also acquires the plurality of contents from the content storage unit. The order determination unit outputs to the screening content generation device, the order information together with the plurality of contents acquired from the content attribute acquisition unit.

The present disclosure relates to a content determination device, a content determination method, and a storage medium.

This application is a Continuation of PCT International Application No. PCT/JP2020/017233 filed on Apr. 21, 2020, which is hereby incorporated by reference into the present application.

### TECHNICAL FIELD

### Background Art

In recent years, contents to be shown have been distributed to display devices of facilities. For example, Patent Document 1 describes acquiring information on an audience located in a facility, and determining, based on this information, a second content such as an advertisement to be provided together with a first content in the facility. In Patent Document 1, when the facility is a movie theater, the first content is a movie to be shown in the movie theater.

### CITATION LIST

### Patent Document

Patent Document 1: Japanese Patent Application Laid-Open Publication No. 2015-135583

### SUMMARY

In movie theaters, a plurality of contents are displayed before a main part of a movie is shown. On the other hand, some of the audience of the movie will be seated just before the main part of the movie is shown, so that they will not see some of the contents. For this reason, it is important to display a plurality of contents in proper order.

An example of an object of the present disclosure is to properly set a display order of a plurality of contents when displaying the plurality of contents before a main part of a movie is shown.

According to the present disclosure, a content determination device is configured to determine a display order of a plurality of contents to be displayed before a main part of a movie. The content determination device includes: content attribute acquisition means configured to acquire a plurality of pieces of content attribute information respectively indicating attributes of the plurality of contents; and order determination means configured to generate, using the plurality of pieces of content attribute information, order information indicating the display order of the plurality of contents, and output the order information to a screening content generation device configured to display the plurality of contents.

According to the present disclosure, a content determination method for a computer to determine a display order of a plurality of contents to be displayed before a main part of a movie includes: acquiring a plurality of pieces of content attribute information respectively indicating attributes of the plurality of contents; generating, using the plurality of pieces of content attribute information, order information indicating the display order of the plurality of contents; and outputting the order information to a screening content generation device configured to display the plurality of contents.

According to the present disclosure, a non-transitory computer-readable storage medium storing a program causes a computer to determine a display order of a plurality of contents to be displayed before a main part of a movie. The program causes the computer to: acquire a plurality of pieces of content attribute information respectively indicating attributes of the plurality of contents; generate, using the plurality of pieces of content attribute information, order information indicating the display order of the plurality of contents; and output the order information to a screening content generation device configured to display the plurality of contents.

According to the present disclosure, when a plurality of contents are displayed before a main part of a movie is shown, a display order of the plurality of contents can be properly set.

### BRIEF DESCRIPTION OF THE DRAWINGS

The above-described objectives and other objectives, features and advantages will be further clarified by preferred embodiments described below and accompanying drawings below.

FIG. 1 is a diagram showing a usage environment of a content determination device according to an embodiment.

FIG. 2 is a diagram showing an example of a functional configuration of the content determination device.

FIG. 3 is a diagram showing an example of data stored in a content storage unit.

FIG. 4 is a diagram showing an example of audience attribute information stored in an audience attribute server.

FIG. 5 is a diagram showing a hardware configuration example of the content determination device.

FIG. 6 is a flowchart showing an example of processing performed by the content determination device.

FIG. 7 is a diagram showing an example of a method of generating order information.

### DETAILED DESCRIPTION

Hereinafter, embodiments of the present disclosure will be described with reference to the drawings. In all the drawings, like components are designated by like reference numerals, and description thereof will be omitted as appropriate.

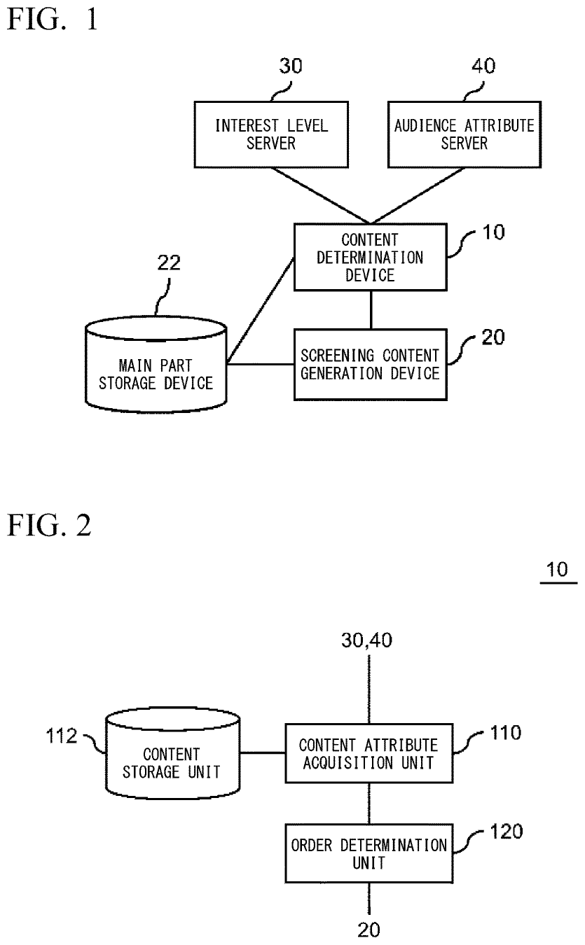

FIG. 1 is a diagram showing a usage environment of a content determination device 10 according to the embodiment. The content determination device 10 determines a display order of a plurality of contents to be displayed before a main part of a movie when the main part of the movie is shown in a movie theater, and order information indicating the display order is transmitted to a screening content generation device 20. At this time, the content determination device 10 also outputs the plurality of contents to the screening content generation device 20. The screening content generation device 20 reads the main part of the movie from a main part storage device 22, and inserts before the main part of the movie, the plurality of contents acquired from the content determination device 10 in the order indicated by the order information, thereby generating a screening content including the main part of the movie and the above-described plurality of contents. Then, the screening content generation device 20 displays the screening content on a screen or display of the movie theater. Here, the screening content generation device 20 may be a part of the content determination device 10.

In the present embodiment, the content determination device 10 also selects a plurality of contents to be outputted to the screening content generation device 20. In this selection, the content determination device 10 uses attribute information of an audience of the main part of the movie (hereinafter referred to as audience attribute information). The content determination device 10 acquires the audience attribute information from an audience attribute server 40. The audience attribute information includes, for example, at least one of an age group and a gender of the audience.

An audience attribute server 40 acquires audience attribute information, for example, when the audience purchases a ticket. This acquisition may be performed, for example, by input from the audience, or by processing an image obtained by capturing the audience. Here, the ticket may be a paper medium or an electronic ticket. In the latter case, the attribute information of the audience may be registered in advance in association with a member ID or the like before the electronic ticket is purchased. In this case, the audience attribute server 40 can also acquire the audience attribute information from a server that manages the registration information. Additionally, in general, movie ticket prices vary between adults and children. Therefore, the audience attribute server 40 may estimate, using the price of the ticket, an age group of the audience, for example, whether the audience is an adult or a child.

Further, when generating the above-described order information, the content determination device 10 uses the attribute information of each of the plurality of contents (hereinafter referred to as content attribute information).

The content handled by the content determination device 10 is, for example, an advertisement. As an example, this content is an advertisement for an unreleased movie that will be released in the future. In this case, the content attribute information has an index indicating a level of interest in the unreleased movie corresponding to the content and a time until a release date of the unreleased movie corresponding to the content. Of these, an interest level server 30 acquires from the interest level server 30, the index indicating the level of interest in the unreleased movie.

The interest level server 30 calculates this index using, for example, the number of times a keyword has been inputted to a search engine on the Internet. For example, the interest level server 30 increases the level of interest as the number of inputs of the title of the unreleased movie increases.

FIG. 2 is a diagram showing an example of a functional configuration of the content determination device 10. In the example shown in this figure, the content determination device 10 includes a content attribute acquisition unit 110 and an order determination unit 120. The content attribute acquisition unit 110 acquires the content attribute information of each of the plurality of contents displayed before the main part of the movie. The order determination unit 120 generates the above-described order information using the plurality of pieces of content attribute information, and outputs the order information to the screening content generation device 20.

Some of the audience of the movie may be seated just before the main part of the movie is shown. For this reason, it may be preferable that the display order of important contents is relatively behind. In such a case, the order determination unit 120 determines a priority of each of the plurality of contents using the plurality of pieces of content attribute information, and generates the order information so that the contents are displayed in the ascending order of the priority. In this way, a large number of audiences will see the high-priority content, that is, important content.

In the present embodiment, the content storage unit 112 stores the content itself as well as the content attribute information. The content attribute acquisition unit 110 acquires the content attribute information from the content storage unit 112, and also acquires the content itself from the content storage unit 112. Then, the content attribute acquisition unit 110 outputs to the order determination unit 120, the plurality of contents read from the content storage unit 112 together with the plurality of pieces of content attribute information. The order determination unit 120 outputs to the screening content generation device 20, the order information together with the plurality of contents acquired from the content attribute acquisition unit 110.

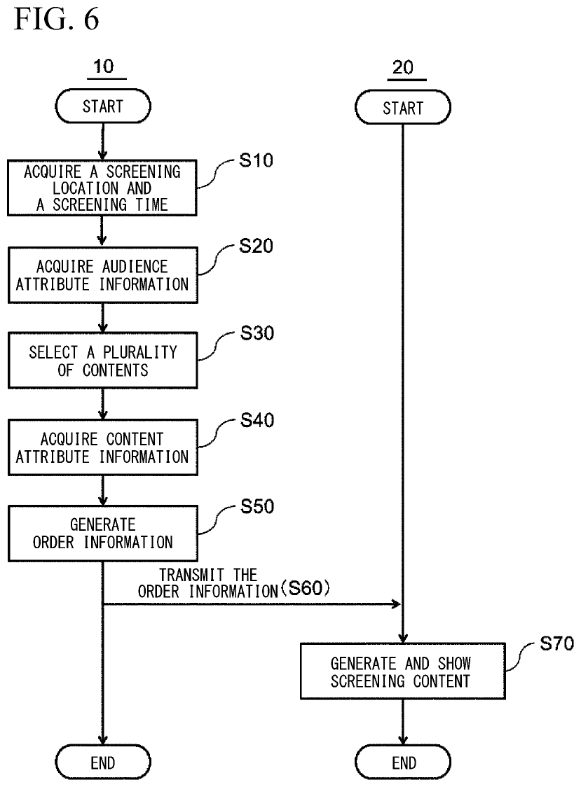

Further, in the present embodiment, the content attribute acquisition unit 110 acquires from the audience attribute server 40, the audience attribute information indicating an attribute of the audience of the main part of the movie, and selects, by using the audience attribute information, a plurality of contents as a current display target. Here, the content attribute acquisition unit 110 selects the display target from the contents stored in the content storage unit 112. An example of the selection criteria here will be described later with reference to FIG. 6.

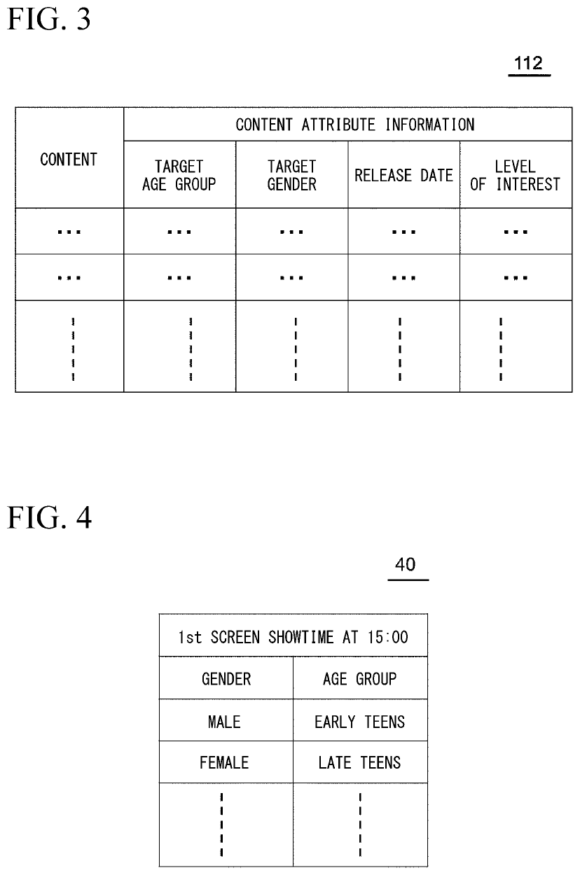

FIG. 3 is a diagram showing an example of data stored in the content storage unit 112. As described above, the content storage unit 112 stores the content attribute information together with the contents. In the example shown in this figure, the content attribute information includes a target age group and a target gender of the content. When the content is information about an unreleased movie, for example, an advertisement for an unreleased movie, the content attribute information includes a release date of the unreleased movie, and an index indicating a level of interest in the unreleased movie (hereinafter referred to as the level of interest). Here, instead of the release date of the unreleased movie, the number of days from the current date to the release date may be stored.

Here, of the content attribute information, the target age group, the target gender, and the release date of the unreleased movie are preset when the content is stored in the content storage unit 112. This setting is made by, for example, a creator (distributor) of the content. On the other hand, the level of interest in the unreleased movie is updated regularly. For example, the content attribute acquisition unit 110 periodically acquires from the level of interest server 30, information for specifying the level of interest, and updates the level of interest using the acquired information.

Further, the main part storage device 22 shown in FIG. 1 may store the main part of the movie in association with the attribute information of the main part of the movie. In this case, it is preferable that the contents of the attribute information of the main part are the same as the content attribute information shown in FIG. 3.

FIG. 4 shows an example of audience attribute information stored in the audience attribute server 40. In the example shown in this figure, the audience attribute server 40 stores, for each screening place (screen number or theater number) and screening time, the audience attribute information of the audience who purchased the ticket of the main part of the movie. As described above, examples of the audience attribute information are the gender and the age group.

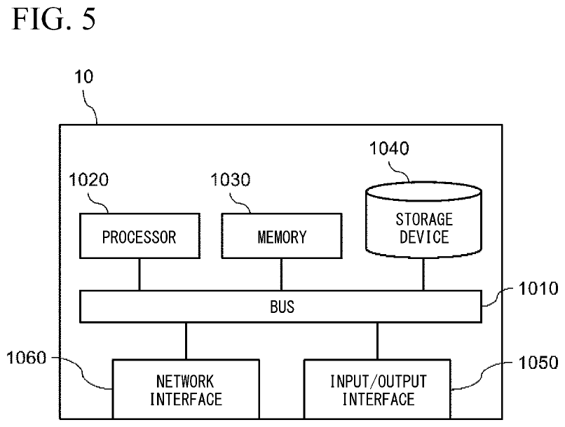

FIG. 5 is a diagram showing a hardware configuration example of the content determination device 10. The content determination device 10 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, a method of connecting the processor 1020 and the like to each other is not limited to the bus connection.

The processor 1020 is a processor realized by a CPU (Central Processing Unit), a GPU (Graphics Processing Unit), or the like.

The memory 1030 is a main storage device realized by a RAM (Random Access Memory) or the like.

The storage device 1040 is an auxiliary storage device realized by an HDD (Hard Disk Drive), an SSD (Solid State Drive), a memory card, a ROM (Read Only Memory), or the like. The storage device 1040 stores a program module that realizes each function of the content determination device 10 (for example, the content attribute acquisition unit 110 and the order determination unit 120). When the processor 1020 reads each of these program modules into the memory 1030 and executes them, each function corresponding to the program module is realized. Further, the storage device 1040 also functions as the content storage unit 112.

The input/output interface 1050 is an interface for connecting the content determination device 10 and various input/output devices. For example, the content determination device 10 may communicate with the screening content generation device 20 via the input/output interface 1050.

The network interface 1060 is an interface for connecting the content determination device 10 to a network. This network is, for example, a LAN (Local Area Network) or a WAN (Wide Area Network). A method of connecting the network interface 1060 to the network may be a wireless connection or a wired connection. The content determination device 10 may communicate with the screening content generation device 20, the interest level server 30, and the audience attribute server 40 via the network interface 1060.

FIG. 6 is a flowchart showing an example of processing performed by the content determination device 10. As described above, the level of interest stored in the content storage unit 112 is periodically updated separately from the processing shown in this figure. Further, the processing shown in this figure is performed, for example, a predetermined time (for example, one hour) before the screening time.

First, the content attribute acquisition unit 110 of the content determination device 10 acquires a screening location and a screening time of the target main part of the movie (step S10). The content attribute acquisition unit 110 acquires these information pieces from, for example, a schedule management device that stores screening schedules of movie theaters. In this case, the content determination device 10 repeatedly connects to the schedule management device, and reads a combination of the screening location and the screening time of a movie for which the time until the screening time is a predetermined time or more.

Then, the content attribute acquisition unit 110 acquires from the audience attribute server 40, the audience attribute information corresponding to the screening location and the screening time acquired in step S10 (step S20). Then, by using the acquired audience attribute information, the content attribute acquisition unit 110 selects a plurality of contents to be displayed before the main part of the movie, from the contents stored in the content storage unit 112, and reads the selected plurality of contents from the storage unit 112 (step S30).

For example, the content attribute acquisition unit 110 aggregates the audiences for each attribute of the audiences (for example, for each combination of gender and age group), and selects a content corresponding to the attribute with the largest number of audiences. Further, the content attribute acquisition unit 110 may aggregate the number of audiences for each attribute of the audiences and determine the number of contents for each attribute of the audiences according to a ratio of the aggregated results.

Here, in these cases, if there is no bias in the attributes of the audiences, for example, if a difference in the number of audiences is less than or equal to a reference value between the attribute with the largest number of audiences and the attribute with the smallest number of audiences, the content attribute acquisition unit 110 may read the attribute information of the main part of the movie from the main part storage device 22 and select a content corresponding to the attribute information.

Then, the number of contents selected in step S30 may be predetermined, may be determined for each main part of the movie, or may be determined for each combination of screening location and screening time.

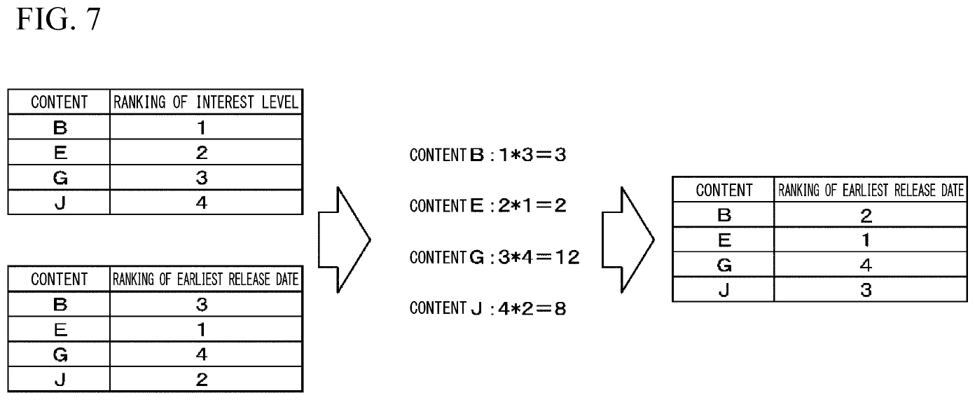

Then, the content attribute acquisition unit 110 reads from the content storage unit 112, the content attribute information pieces of the plurality of contents selected in step S30 (step S40). Then, the order determination unit 120 generates the above-described order information using these content attribute information pieces (step S50), and transmits to the screening content generation device 20, the order information together with the plurality of contents read in step S30 (step S60). An example of generating the order information will be described later with reference to FIG. 7.

Then, the screening content generation device 20 reads the main part of the movie, and inserts before the main part of the movie, the plurality of contents acquired from the content determination device 10 in the order indicated by the order information, thus generating a screening content. The screening content includes the plurality of contents acquired from the content determination device 10 and the main part of the movie in this order. Then, the screening content generation device 20 displays the screening content on the screen or display of the movie theater (step S70).

FIG. 7 is a diagram showing an example of a method of generating order information. In the example shown in this figure, the order determination unit 120 sets the order of the contents by using the level of interest and the time until the release date of the unreleased movie. For example, the order determination unit 120 sets a first provisional ranking in descending order of the interest level, and sets a second provisional ranking in ascending order of the time until the publication date. It can be said that these provisional rankings indicate a level of attention (priority) of the content. Then, the order information is generated by arithmetically processing the first provisional ranking and the second provisional ranking. This arithmetic processing may be multiplication or addition. Further, the order determination unit 120 may multiply at least one of the first provisional ranking and the second provisional ranking by a predetermined coefficient before performing the arithmetic processing.

Then, the order determination unit 120 may advance the display timing as a result of the calculation becomes larger. By doing so, it is possible to show the content with higher attention to a larger audience.

In the example shown in FIG. 7, the order determination unit 120 may advance the display timing as a result of arithmetic processing of the first tentative rank and the second tentative rank becomes smaller. By doing so, it is possible to make a large audience aware of the existence of the content with a low level of attention.

As described above, according to the present embodiment, the content determination device 10 determines the display order of the plurality of contents displayed before the main part of the movie by using the attribute information pieces of the plurality of contents. Therefore, these plurality of contents can be displayed in proper order. In addition, the cost of determining the display order of the contents is reduced.

Although the embodiments of the present disclosure have been described above with reference to the drawings, these are examples of the present disclosure, and various configurations other than the above can be adopted.

Further, in the plurality of flowcharts used in the above description, the plurality of steps (processes) are described in order, but the execution order of the steps executed in each embodiment is not limited to the described order. In each embodiment, the order of the illustrated steps can be changed within a range that does not hinder the contents. In addition, the above-described embodiments can be combined as long as the contents do not conflict with each other.

A part or all of the above embodiments may be described as, but is not limited to, the following notes.

1. A content determination device configured to determine a display order of a plurality of contents to be displayed before a main part of a movie, the content determination device comprising:

content attribute acquisition means configured to acquire a plurality of pieces of content attribute information respectively indicating attributes of the plurality of contents; and

order determination means configured to generate, using the plurality of pieces of content attribute information, order information indicating the display order of the plurality of contents, and output the order information to a screening content generation device configured to display the plurality of contents.

2. The content determination device of note 1, wherein

the order determination means is configured to determine priorities of the plurality of contents using the plurality of pieces of the content attribute information and generate the order information so that the plurality of contents are displayed in ascending order of the priorities.

3. The content determination device of note 1 or 2, wherein

at least one of the plurality of contents includes an advertisement.

4. The content determination device of note 3, wherein:

at least one of the plurality of contents includes an advertisement for an unreleased movie to be released in a future, and

at least one of the plurality of pieces of content attribute information, which corresponds to the at least one of the plurality of contents, includes an index indicating a level of interest in the unreleased movie and a time until a release date of the unreleased movie.

5. The content determination device of any one of notes 1 to 4, wherein

the content attribute acquisition means is further configured to acquire audience attribute information indicating an attribute of an audience of the main part of the movie and select the plurality of contents using the audience attribute information.

6. A content determination method for a computer to determine a display order of a plurality of contents to be displayed before a main part of a movie, wherein the computer is configured to perform:

a content attribute acquisition process of acquiring a plurality of pieces of content attribute information respectively indicating attributes of the plurality of contents; and

an order determination process of generating, using the plurality of pieces of content attribute information, order information indicating the display order of the plurality of contents, and outputting the order information to a screening content generation device configured to display the plurality of contents.

7. The content determination method of note 6, wherein:

in the order determination process, the computer is configured to determine priorities of the plurality of contents using the plurality of pieces of the content attribute information, and generate the order information so that the plurality of contents are displayed in ascending order of the priorities.

8. The content determination method of note 6, wherein

at least one of the plurality of contents includes an advertisement.

9. The content determination method of note 8, wherein:

at least one of the plurality of contents includes an advertisement for an unreleased movie to be released in a future, and

at least one of the plurality of pieces of content attribute information, which corresponds to the at least one of the plurality of contents, includes an index indicating a level of interest in the unreleased movie and a time until a release date of the unreleased movie.

10. The content determination method of any one of notes 6 to 9, wherein

in the content attribute acquisition process, the computer is further configured to acquire audience attribute information indicating an attribute of an audience of the main part of the movie, and select the plurality of contents using the audience attribute information.

11. A non-transitory computer-readable storage medium storing a program causing a computer to determine a display order of a plurality of contents to be displayed before a main part of a movie, the program causing the computer to:

acquire a plurality of pieces of content attribute information respectively indicating attributes of the plurality of contents;

generate, using the plurality of pieces of content attribute information, order information indicating the display order of the plurality of contents; and

output the order information to a screening content generation device configured to display the plurality of contents.

12. The non-transitory computer-readable storage medium of note 11, wherein the program further causes the computer to:

determine priorities of the plurality of contents using the plurality of pieces of the content attribute information; and

generate the order information so that the plurality of contents are displayed in ascending order of the priorities.

13. The non-transitory computer-readable storage medium of note 11 or 12, wherein at least one of the plurality of contents includes an advertisement.
14. The non-transitory computer-readable storage medium of note 13, wherein:

at least one of the plurality of contents includes an advertisement for an unreleased movie to be released in a future, and

at least one of the plurality of pieces of content attribute information, which corresponds to the at least one of the plurality of contents, includes an index indicating a level of interest in the unreleased movie and a time until a release date of the unreleased movie.

15. The non-transitory computer-readable storage medium of any one of notes 11 to 14, wherein the program further causes the computer to:

acquire audience attribute information indicating an attribute of an audience of the main part of the movie; and

select the plurality of contents using the audience attribute information.

16. A content determination device configured to determine a display order of a plurality of contents to be displayed before a main part of a movie, the content determination device comprising:

content selection means configured to acquire audience attribute information indicating an attribute of an audience of the main part of the movie, and select the plurality of contents using the audience attribute information.

1. A content determination device configured to determine a display order of a plurality of contents to be displayed before a main part of a movie, the content determination device comprising:
a processor; and
a memory storing instructions causing the processor to:
acquire a plurality of pieces of content attribute information respectively indicating attributes of the plurality of contents;
generate, using the plurality of pieces of content attribute information, order information indicating the display order of the plurality of contents; and
output the order information to a screening content generation device configured to display the plurality of contents.

2. The content determination device of claim 1, wherein
the instructions further causes the processor to:
determine priorities of the plurality of contents using the plurality of pieces of the content attribute information; and
generate the order information so that the plurality of contents are displayed in ascending order of the priorities.

3. The content determination device of claim 1, wherein
at least one of the plurality of contents includes an advertisement.

4. The content determination device of claim 1, wherein:
at least one of the plurality of contents includes an advertisement for an unreleased movie to be released in a future, and
at least one of the plurality of pieces of content attribute information, which corresponds to the at least one of the plurality of contents, includes an index indicating a level of interest in the unreleased movie and a time until a release date of the unreleased movie.

5. The content determination device of claim 1, wherein
the instructions further causes the processor to:
acquire audience attribute information indicating an attribute of an audience of the main part of the movie; and
select the plurality of contents using the audience attribute information.

6. A content determination method for a computer to determine a display order of a plurality of contents to be displayed before a main part of a movie, the content determination method comprising:
acquiring a plurality of pieces of content attribute information respectively indicating attributes of the plurality of contents;
generating, using the plurality of pieces of content attribute information, order information indicating the display order of the plurality of contents; and
outputting the order information to a screening content generation device configured to display the plurality of contents.

7. The content determination method of claim 6, further comprising:
determining priorities of the plurality of contents using the plurality of pieces of the content attribute information; and
generating the order information so that the plurality of contents are displayed in ascending order of the priorities.

8. The content determination method of claim 6, wherein
at least one of the plurality of contents includes an advertisement.

9. The content determination method of claim 6, wherein:
at least one of the plurality of contents includes an advertisement for an unreleased movie to be released in a future, and
at least one of the plurality of pieces of content attribute information, which corresponds to the at least one of the plurality of contents, includes an index indicating a level of interest in the unreleased movie and a time until a release date of the unreleased movie.

10. The content determination method of claim 6, further comprising:
acquiring audience attribute information indicating an attribute of an audience of the main part of the movie; and
selecting the plurality of contents using the audience attribute information.

11. A non-transitory computer-readable storage medium storing a program causing a computer to determine a display order of a plurality of contents to be displayed before a main part of a movie, the program further causing the computer to:
acquire a plurality of pieces of content attribute information respectively indicating attributes of the plurality of contents;
generate, using the plurality of pieces of content attribute information, order information indicating the display order of the plurality of contents; and
output the order information to a screening content generation device configured to display the plurality of contents.

12. The non-transitory computer-readable storage medium of claim 11, wherein the program further causes the computer to:
determine priorities of the plurality of contents using the plurality of pieces of the content attribute information; and
generate the order information so that the plurality of contents are displayed in ascending order of the priorities.

13. The non-transitory computer-readable storage medium of claim 11, wherein
at least one of the plurality of contents includes an advertisement.

14. The non-transitory computer-readable storage medium of claim 11, wherein:
at least one of the plurality of contents includes an advertisement for an unreleased movie to be released in a future, and
at least one of the plurality of pieces of content attribute information, which corresponds to the at least one of the plurality of contents, includes an index indicating a level of interest in the unreleased movie and a time until a release date of the unreleased movie.

15. The non-transitory computer-readable storage medium of claim 6, wherein the program further causes the computer to:
acquire audience attribute information indicating an attribute of an audience of the main part of the movie; and
select the plurality of contents using the audience attribute information.
